(19) United States
(12) Patent Application Publication
(10) Pub. No.: US 2015/0273544 A1
(43) Pub. Date: Oct. 1, 2015

(54) Process For Soil Remediation

(71) Applicant: Robert L. Gallagher, Weston, FL (US)

(72) Inventor: Robert L. Gallagher, Weston, FL (US)

(21) Appl. No.: 14/231,518

(22) Filed: Mar. 31, 2014

(51) Int. Cl. B09C 1/00; B09C 1/06; B09C 1/10; B09C 1/02; B09C 1/08

(52) U.S. Cl. CPC B09C 1/005; B09C 1/00; B09C 1/02; B09C 1/08; B09C 1/10; B09C 1/06

(57) ABSTRACT

A method of remediating a contaminant from soil is provided. According to the present method, clean (uncontaminated) soil is mixed with contaminated soil in a ratio that provides for remediation of the contaminant. The soil mixing method utilizes soil vibration and water as a hydraulic medium to achieve mixing of the clean and contaminated soil such that the contaminated soil is distributed homogeneously throughout the mixed soil to bring the level of contamination of the soil contaminant to within an acceptable level.

### BACKGROUND

Soil is a crucial component of rural, urban and suburban environments. Mining, manufacturing, and the use of synthetic products (e.g., pesticides, fertilizers, paints, batteries, industrial waste, and land application of industrial or domestic sludge) can result in heavy metal contamination of soil. Heavy metals also occur naturally, but rarely at toxic levels. Potentially contaminated soils may occur at old landfill sites (particularly those that accepted industrial wastes), old orchards that used insecticides or pesticides containing arsenic or other metals as an active ingredient, fields that had past applications of waste water or municipal sludge, areas in or around mining waste piles and tailings, industrial areas where chemicals may have been dumped on the ground, or in areas downwind from industrial sites.

Excess heavy metal accumulation, such as lead, arsenic, chromium, cadmium, zinc and nickel, for example, in soils is toxic to humans and other animals. Chronic problems associated with long-term heavy metal exposures include cancers, cardiovascular disease, kidney and liver disease, diabetes, anemia, as well as reproductive, developmental, immunological and neurological effects.

It is widely recognized that years of industry has produced numerous environmentally hazardous sites throughout the country and the world which pose substantial health hazards to the world's population. In recent years, efforts to clean up or remediate environmentally contaminated sites have increased dramatically. Numerous methods and devices for cleaning up or disposing of environmental contamination in soil have been devised, and the magnitude of the environmental contamination is enormous in comparison to the resources made available to solve this problem.

To address the problem of soil treatment of contaminated soil, decontamination techniques have been developed. These techniques involve, but are not limited to the application of fluids, biological agents, heat, vacuum, pressurized gases, and mechanical agitation. Remediation of heavy metals in soil is particularly difficult, as known remediation methods are typically limited to excavation and ex situ treatment by solidification/stabilization, soil washing/extraction, and pyrometallurgical recovery by heat extraction. A discussion of remediation methods and devices can be found, for example, in U.S. Pat. No. 5,988,947, and Martin, T. A., and Ruby, M. V., “In Situ Remediation of Arsenic in Contaminated Soils”, Remediation, Winter 2003, pp 21-32. Disadvantageously, however, these remediation methods are very expensive. In situ stabilization methods include immobilization beneath an impervious engineered cap, such as a roadway or parking lot, or placing in landscape berms with a clean cover cap. In situ stabilization is generally less expensive than removal and disposal or remediation. Disadvantageously, however, these methods require that the contamination soil be placed below the water table, resulting in disclosure language to prospective land purchasers and conforming to local leaching requirements; and deed restrictions, which lower property values and require ongoing maintenance in perpetuity and any subsequent subsurface excavation will require additional soil sampling, analysis and offsite disposal of contaminated soil.

Soil blending techniques, i.e., mixing portions of contaminated and uncontaminated soil are known. However, these techniques are limited in that the effectiveness of the remediation strategy is often limited by the ability to distribute the contaminant throughout the soil medium continuously, such that the remediated soil will not have portions with elevated contaminant.

Accordingly, there is a need for improved methods and apparatus to overcome the above-described limitations in the area, which are cost effective. There is also a need for a soil remediation method which will result in non-contaminated soil, free from deed restrictions and other perpetual maintenance requirements, which preferably can be performed in situ.

### SUMMARY

According to the present invention, a method of remediating a contaminant from soil is provided. The method comprises identifying a land parcel having at least one soil contaminant that exceeds a desired level of contaminant. Within the land parcel, a portion of soil having an excess concentration of at least one soil contaminant is identified. The contaminated soil is excavated and the amount of contaminant in the soil is identified. An amount of uncontaminated soil is calculated which, when blended with the contaminated soil, achieves a desired level of contaminant. The excavated portion of soil with the at least one soil contaminant is mixed with the uncontaminated soil to form a mixed soil, such that the mixed soil conforms to the desired level of contaminant within the soil. Preferably, the contaminant is distributed substantially consistently throughout the mixed soil. The soil mixing step comprises blending the contaminated soil with the uncontaminated soil using water as a hydraulic medium and soil vibration.

In some embodiments, the contaminated soil comprises two or more soil contaminants and the soil mixing and blending remediates at least two contaminants. And in other embodiments, the method further comprising treating one of the mixed soil or the contaminated soil with a second soil remediation process, where the second soil remediation process is selected from the group consisting of aeration, bioremediation, in situ oxidation, soil washing, solid vapor extraction and thermal desorption.

The present invention addresses and solves many of the above-mentioned problems associated with currently available remediation methods. The method described herein is cost effective, results in a non-contaminated soil (i.e., soil that conforms to Federal, state, and county regulations for the contaminant) and can be performed in situ. As the soil conforms to regulatory limits, the remediated property can be transferred free from deed restrictions and other perpetual maintenance requirements.

### FIGURES

These and other features, aspects and advantages of the present invention will become better understood from the following description, appended claims, and accompanying figures where:

FIG. 1 is a flow chart illustrating a method according to one embodiment of the invention; and

FIG. 2 is a flow chart illustrating a method according to another embodiment of the invention.

### DETAILED DESCRIPTION

According to the present invention, a method for remediation of soil having one or more undesired contaminants is provided. According to the present invention, contaminated soil, excavated from a site, or land parcel identified as having contaminated soil is mixed with clean soil. As used herein, clean soil refers to soil which is substantially free of known or identifiable hazardous substances. The soil mixing process substantially uniformly blends the soil to reduce concentrations of the contaminant to an acceptable level, as determined by currently accepted environmental regulations.

The method of soil remediation described herein reduces the contamination level in the soil to an acceptable level such that the soil does not need to be removed or otherwise treated, thus removing the need for a deed restriction or other disclosure when the property is transferred. The method is a cost effective way of soil treatment without having to remove soil offsite for ex situ treatment and/or toxic waste disposal.

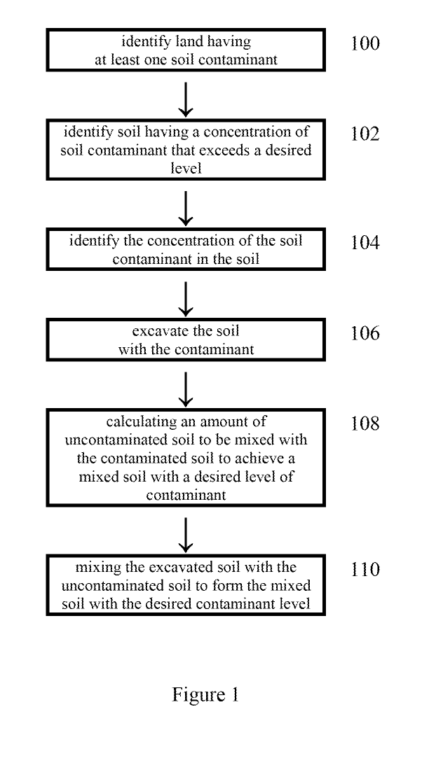

Referring now to FIG. 1, a flow chart illustrating one embodiment of the method of remediating a contaminant from soil is shown. As shown in FIG. 1, first, a land parcel having at least one soil contaminant is identified 100. The soil contaminant exceeds a desired level, which is known to those of skill in the art, depending on the particular soil contaminant, but typically, the desired level of soil contaminant is one that is below state and federal regulated levels for that contaminant. Next, within the land parcel, a portion of soil having a concentration of the at least one soil contaminant that exceeds the desired level of contaminant is identified 102. The concentration of the soil contaminant in the portion of soil is then identified 104 and the identified portion of soil with the at least one soil contaminant is excavated 106, and in place is left an excavation site. An amount of uncontaminated soil to be mixed with the portion of soil with at least one soil contaminant is then calculated 108. The amount of uncontaminated soil to be mixed with the contaminated soil is the amount, which, when blended will achieve a desired level of contaminant. In a mixing step 110, he excavated portion of soil having the at least one soil contaminant is then mixed with uncontaminated soil to form a mixed soil, such that the mixed soil corresponds to the desired level of contaminant within the soil in a mixing step. The mixing step 110 comprises blending the contaminated soil with the uncontaminated soil using water as a hydraulic medium. Preferably, the contaminant is distributed substantially consistently throughout the mixed soil.

In a preferred embodiment, the soil contaminant is Arsenic. However, the method can be used to remediate one or more other soil contaminants such as lead, chromium, cadmium, zinc and nickel, for example, or other soil contaminants toxic to humans and other animals.

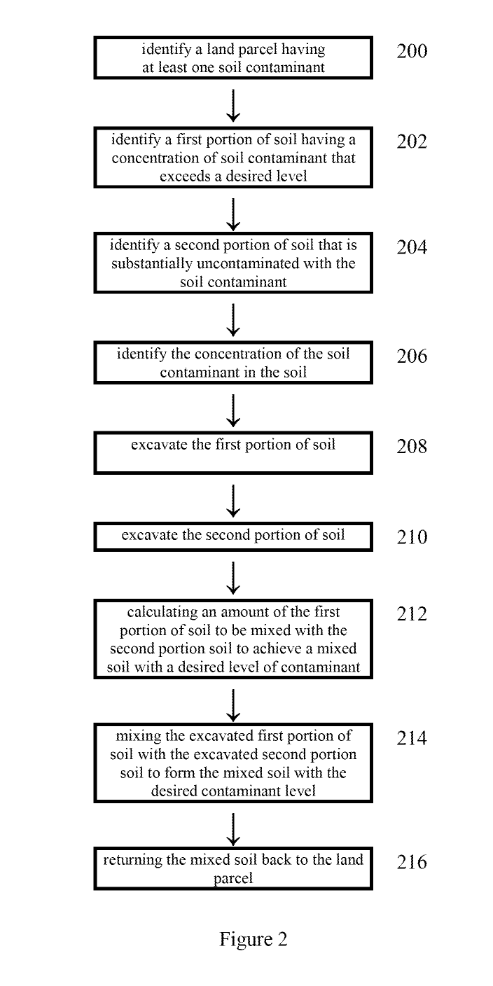

Referring now to FIG. 2, a flow chart illustrating another embodiment of the method of remediating a contaminant from soil is provided. As shown in FIG. 2, first, a land parcel having at least one soil contaminant is identified 200. Next, a first portion of soil within the land parcel is identified having a concentration of a soil contaminant that exceeds a desired level 202. Then, a second portion of soil within the land parcel is identified that is substantially uncontaminated with the soil contaminant 204. The concentration of the soil contaminant in the first portion of soil is then identified 206. Then, the first and second portions of soil are excavated 208, 210. The amount of the first portion of soil to be mixed with the second portion of soil to attain the desired level of contaminant 212 is calculated. In a mixing step 214, the excavated portion of the first portion of soil is mixed with the second portion of soil to form a mixed soil. The mixed soil conforms to the desired level of contaminant within the soil, and preferably, the contaminant is distributed substantially uniformly throughout the mixed soil. The mixing step comprises blending the first portion of soil with the second portion of soil using water as a hydraulic medium. Optionally, in some embodiments, the mixed soil is returned back to the parcel of land 216, and may be placed in any of a variety of desirable sites, including under roadways, or in landscapes, and in residential plots. In other embodiments, the mixed soil is removed or moved to an alternate site.

Preferably, the concentration of the soil contaminants in the first portion of soil is qualitatively identified by known analytic methods, such as Synthetic Precipitation Leaching Procedure (SPLP) tests for arsenic, and/or EPA Method 6010 for total arsenic.

In some embodiments, in step 204, three, four or more additional portions of soil that are not completely uncontaminated, but have a lesser contamination level, which does not exceed the desired level of contaminant are identified and the concentration of the soil contaminant in each portion is identified. One or more of these additional portions of soil, alone or with the second portion of soil, may be excavated and mixed with the first portion of soil, as described herein, to achieve a mixed soil with a desired contamination level.

Referring again to FIG. 1 and FIG. 2, the mixing step 110, 214 comprises combining the contaminated soil with the uncontaminated soil using water as a hydraulic medium and blending with a vibroflotation device.

The mixing step 110, 214 comprises first, introducing a hydraulic medium comprising water, and optionally a surfactant and an emulsifier into an area for the soil to be mixed (i.e., the mixing area), which may be the excavation site, or another area where the mixed soil is to be placed. When the mixed soil is to be returned back to the land parcel 216, as described with reference to FIG. 2, the mixing area may be the excavation site, alternately, when the soil is to be removed, the mixing area may be another temporary or permanent off-site area for the mixed soil to be placed. Next, the first and second soil portions are added to the mixing site, in the predetermined ratio, and a vibroflotation machine is used to mix and blend the soil. According to the process, the vibratoflotation machine penetrates the soil by means of the machine's weight and vibrations. The first and second soils are mixed in the desired ratio and introduced at the ground surface to the annular space around the vibratoflotation machine. The vibratoflotation machine mixes and blends the soil and the process is repeated until the mixed soil is blended.

According to one embodiment, the hydraulic medium is introduced into the mixing area using a pump device, such as a trash pump, for example a PT3-100HAT-570 gallon per minute trash pump with a Honda GX Engine. In a preferred embodiment, water is introduced into the mixing area with the pump device, preferably at 570 gallons per minute (GPM). A suction line may be introduced in the pump intake to inject an anionic surfactant, at for example, 0.005 gallons per minute into the water. Suitable anionic surfactants, also referred to as a foaming agent, into the water. Suitable anionic surfactants may include surfactants contain anionic functional groups at their head, such as sulfate and sulfonate functional groups, and phosphate and carboxylate functional groups. Examples include ammonium lauryl sulfate, sodium lauryl sulfate, and the related alkyl-ether sulfates sodium laureth sulfate, also known as sodium lauryl ether sulfate (SLES), and sodium myreth sulfate. An emulsifier, such as glyceryl behenate may also be introduced into the dispersion medium via the suction line, at for example, 0.0025 gallons per minute. The first and second portions of soil (i.e., contaminated and uncontaminated soil) are introduced into the mixing area at the desired ratio, as described herein, to achieve a mixed soil with the desired level of contaminant. The first and second portions of soil (or also third and fourth portions of soil, as described herein) are introduced into the mixing area using soil moving equipment, such as bull dozers and/or backhoes as well as other soil mixing and blending equipment as known in the art.

As described herein, a vibroflotation machine is then used to mix and blend the soil. The hydraulic medium is introduced into the mixing site via a pump with a suction intake. However, other embodiments are possible, such as a pre-mixed medium, as will be understood by those of skill in the art. Further description of the process and suitable equipment is described in CABE Associates, Inc., Bonaventure partners, LLC, Weston, Fla., SAR/RAP Combined Report, dated August 2013, titled “In Situ Arsenic Remediation via Hydraulic Soils Augmentation Utilizing the Gallagher Method”, incorporated herein by reference in its entirety.

As an example of the above described method, first, a land site having high concentrations of a soil contaminant, such as arsenic, is identified (200). On the land site, a first portion of soil, such as the top soil layer is found to have the soil contaminant (202). The next layer of soil, e.g., the intermediate layer, next 18 inches of soil was found to have medium to high concentrations of the soil contaminant, and the lower layer of soil, e.g., from 24 inches to 48-60 inches was uncontaminated (204). The three layers of soil are excavated and placed in separate piles (208, 210). The amount of contaminated soil from the top and intermediate layers to be mixed with the lower uncontaminated layer is calculated (212). The top soil layer (i.e., first layer) and the intermediate soil layer are bulk blended in a hydraulic medium with the lower soil layer, as described herein, to form a mixed soil which conforms to acceptable levels of the contaminant so that the contaminated top and intermediate layers of soil do not have to be removed offsite to toxic waste disposal (214).

The soil remediation method, as described herein is performed in-situ and without the aid of other remediation techniques such as thermal remediation, or the addition of other solid stabilizers such as clay or cementitious (e.g., concrete, lyme) stabilizers.

### EXAMPLES

### Example 1

### Soil Blending Pilot Study

A. Background.

A land parcel (site) having a top portion which was contaminated with arsenic was identified. The land parcel was historically used as a golf course and had been sprayed with arsenic containing maintenance products over a significant period of time which led to the soil contamination. As part of a proposed land development proposal, to build single family homes on the property, new lake excavation area were required as well as filling in of some existing lakes on the site. Each new home lot was required to be demucked and filled to construction grade for the contemplated new home.

A Phase I environmental report of the entire site showed evidence of arsenic present in high concentrations in the top 0 to 6 inches of the soil. The next layer from 6 to 24 inches also displayed elevated arsenic levels in amount that a soils assessment report was required and a remedial action plan was stipulated by Federal, State, and County Agencies.

Four courses for removing the contaminated soil were proposed including: 1) placing the contaminated soil beneath proposed roadways; 2) placing the contaminated soil in residential parcels beneath the water table; 3) placing the contaminated soil in landscape berms with a clean cover cap; and 4) placement in existing lakes and proposed lakes as blanket of arsenic-impacted soil to required depth. Each of the above had limitations due to deed restrictions, cost, and or future environmental impact.

It was proposed as a fifth option that the concentration of arsenic could be reduced by blending contaminated and uncontaminated soils to achieve the desired/required arsenic level in the soil, thus eliminating the need for costly removal and other remediation options 1)-4). It was determined that the fifth option, a soil blending method, as described herein, adequately remediated the soil to comply with regulatory levels, in accordance with the goals of: protecting the well-being of the future residents, employees and visitors of various components of the proposed development of the Property; assuring the proposed land uses were in compliance with applicable Florida direct exposure SCTLs (soil cleanup target level (SCTL)) for arsenic; and minimizing the need for offsite disposal of arsenic-impacted soil.

B. The Land Parcel.

The existing Property encompassed approximately 121 acres of land in Westin, Fla. It was proposed to develop the Property with a combination of single-family homes, open space/recreation, stormwater management lakes and buffers. Bonaventure West Golf Course is the western of two golf courses, which constitutes the Bonaventure Country Club and is located at 200 Bonaventure Boulevard, Weston, Broward County, Florida (the Property). The Property is bound by State Road 84 to the north, Bonaventure Boulevard to the east, Saddle Club Road to the south and Racquet Club Road to the west. The Property is approximately 121.155 acres in size and is currently improved with an 18-hole golf course, nine holes within the northern half (North Course) and nine holes within the southern half (South Course)

C. Soil Assessment.

The extent and concentrations of arsenic-impacted soil within the Property were evaluated and documented. As detailed below, the unsaturated soils from 0-1 ft bls are defined as arsenic impacted based on the results of the multiple sampling events. No statistically significant arsenic impacts were identified beneath 1 ft bls. Areas of the Property that were considered impacted by arsenic in excess of the Florida Residential Exposure SCTL of 2.1 mg/kg were identified by soil boring samples as follows:

1. SPLP Sampling I (February 2013). Synthetic Precipitation Leaching Procedure (SPLP) tests for arsenic were previously conducted on 68 unsaturated soil samples, which had representatively low, medium and high concentrations of arsenic. Results of this SPLP test confirmed onsite soils leach arsenic to groundwater at a rate in excess of the 10 μg/L as defined in Chapter 62-550, F.A.C.

The SPLP results did not correlate well with the corresponding arsenic concentrations to soil and groundwater, i.e. high arsenic concentrations in soil did not correspond to high SPLP results or high groundwater concentrations in that region. An additional assessment of soil leachability study targeting soil type as well as prior land use (GCPA vs. rough) was then conducted. Eighteen (18) soil samples were selected from the February 2013 transect soil sampling effort, representing multiple locations across the Property. Each sample was analyzed for total arsenic and SPLP leachate potential. Eight (8) of the SPLP samples exhibited concentrations of arsenic in excess of the Florida GCTL of 10 μg/L and ranged from 220 10 μg/L to BDL.

2. SPLP Sampling II (June 2013). The existing data set was considered to be incomplete due to the relative prevalence of peat material of highly-organic soils onsite. It was also determined that there was a need for additional SPLP data to allow for a more comprehensive statistical evaluation of the propensity for soils to leach arsenic to groundwater. An additional 15 soil samples of unsaturated soil from 0-2 ft bls were then collected that exhibited high levels of organic material based on visual observations. Each sample was analyzed for total arsenic and SPLP leachate potential. The total arsenic concentrations for this sampling event ranged from 0.68 mg/kg to 16.0 mg/kg. None of the 15 SPLP samples exhibited concentrations of arsenic above the MCL of 10 μg/L. Due to the universally low potential for these soil samples to leach arsenic to the groundwater, the corresponding higher organic content in the soil samples appears to positively relate to the absence of the potential to leach arsenic to groundwater.

3. SPLP Sampling III (July 2013). As a continuation of the June 2013 SPLP sampling effort an additional SPLP data, a set of 20 soil samples were collected on Jul. 22-23, 2013 at random locations across the Property from 0-2 ft bls. Ten samples were collected from the lower course and ten samples collected from the upper course. Each sample was a composite of four (4) discrete samples collected from within an approximate 90,000 square foot quadrant. Subsequent to the sample collection and compositing process, the laboratory indicated that eight of the ten composite samples collected from the upper course did not have sufficient sample volume for SPLP analysis. Therefore, only 12 of the 20 SPLP samples were analyzed from this sampling effort.

The total arsenic concentrations for this sampling event ranged from 0.31 mg/kg to 11.0 mg/kg. None of the 12 SPLP samples exhibited concentrations of arsenic above the MCL of 10 μg/L. The results of the SPLP analysis depicted consistently low arsenic concentrations, again confirming that onsite arsenic-impacted soils from 0-2 ft bls do not have the potential to leach arsenic in excess of the Florida MCL for arsenic of 10.0 μg/L.

4. Transect Sampling. Initially, the golf course playing area boundaries were identified from historical aerial photographs depicting greens, tees and fairways of the current golf course playing areas. Based on assessment activities conducted on similar former golf courses in Florida, it was considered likely that areas of the GCPA would exhibit correspondingly higher concentrations of arsenic than in the non-GCPA (rough).

The compilation of existing soil analytical data appears to confirm that the historical practice of application of MSMA has resulted in elevated concentrations of arsenic in unsaturated soil at the Property. A review of the data set did not identify any specific areas of elevated arsenic impacts to the soil within the Property, which would likely have been the result of improper application rates or spillage of MSMA in the past.

From our preliminary evaluation of the data sets, it appears that the 0-2 ft bls arsenic concentrations appear consistently elevated within the Property irrespective of the ground surface elevation. It does not appear that arsenic impacts are solely limited to the golf course playing areas (greens, tees and fairways), although the soil data did reflect higher arsenic concentrations in the golf course greens and tees than the fairways and rough areas of the South Course.

Arsenic concentrations exhibited by soil samples previously collected from 2-4 ft bls were substantially lower than their corresponding samples from 0-2 ft bls. Analytical data from 2-4 ft bls appeared to be in general compliance with the Residential Exposure SCTL of 2.1 mg/kg for arsenic.

Based on the review of the existing soil sampling data, additional source and transport mechanisms were considered as a factor contributing to the observed distribution of arsenic impacts to the upper layers of unsaturated soil within the Property. Regarding additional sources of arsenic impacts onsite, our review of documents regarding the Bonaventure Country Club golf course maintenance area and adjoining portions of the golf course did not identify any other possible source of arsenic impacts to the Property other than the presumed application of arsenical herbicides to the Property.

Based on the existence of low permeability soils previously referenced in §5.2.3 at or near the ground surface, it seemed likely that stormwater runoff from the GCPAs may have acted as a transport mechanism to carry arsenic impacts from the GCPAs (where they were purportedly initially applied) towards the surrounding rough and non-playing areas of the Property. To evaluate this theory, twenty (20) sampling transects were defined within the Property based on the following criteria:

a. Proximal areas of rough (within 20 ft of existing GCPAs) likely to receive stormwater runoff from the nearby GCPAs. but far enough away so that direct application of arsenical herbicides would not contribute to documented arsenic impacts;

b. Lower elevation with respect to the nearby GCPA so stormwater runoff would be the contributing factor to arsenic impacts;

c. Higher elevation with respect to the nearby GCPA so stormwater runoff was not a contributing factor to arsenic impacts; and

d. Varying the previous three criteria for all types of GCPAs (greens, tees and fairways).

Additional transect sampling was done on Feb. 19-20, 2013 and again on Feb. 25-26, 2013. Two hundred and seventeen (217) soil borings were advanced within the 20 transects at the Property. Ten transects (16-25) were located within the North Course and ten transects (5-11, 13-15) were located within the South CoLlrse. A total of 433 soil samples were collected from these soil boring locations for analysis by EPA Method 6010 for total arsenic. Discrete soil samples were collected from each soil boring at depth intervals of 0-24 in bls and 24-48 in bls.

Arsenic concentrations ranges in the soil samples are as follows:
Samples from 0-24 in bls ranged from 45 mg/kg to BDL;
Samples from 24-48 in bls ranged from 42 mg/kg to BDL.

The arsenic concentration data from all the transect lines was compiled and analyzed using the USEPA's ProUCL Version 5 software. The program was run with all possible distribution tests in order to determine the distribution type that the data set followed best. The ProUCL-recommended UCL95 was 2.41 mg/kg for 24-48 in bls. A statistical review of the 24-48 in bls data set revealed a single data point (18-1B@42 mg/kg) defined by the ProUCL software as a clear statistical outlier. On Jun. 26, 2013, six (6) additional soil samples at the location were collected. As each SAR soil sample location was previously documented using GPS equipment, the three (3) verification soil borings were placed within 18 inches of the original sample location. Representative soil samples were collected from each boring at 0-2 and 2-4 ft bls for analysis by EPA Method 6010 for total arsenic.

Arsenic concentrations documented in three verification soil samples were as follows:

| | 0-2 ft bls | 2-4 ft bls Boring |
|---|---|---|
| Boring 1 | 18A: 21 mg/kg | 18B: 1.1 mg/kg |
| Boring 2 | 18C: 3.4 mg/kg | 18D: 2.4 mg/kg |
| Boring 3 | 18E: 21 mg/kg | 18F: 1.5 mg/kg |
| Avg Conc. | 15.1 mg/kg | 1.7 mg/kg |
| Original Data: | 18-1A: 21 mg/kg | 18-1B: 42 mg/kg |

The analytical data for each of the three (3) 18-1A verification soil samples (18A, 18C and 18E) exhibited arsenic concentrations which were comparable to the original 18-1A data point of 21 mg/kg. The data from each of the three (3) 18-1B verification soil samples (18B, 18D and 18F) exhibited arsenic concentrations substantially lower than the original 18-1B data point. These results appear to confirm the allegation that the original18-1B data point of 42 mg/kg is not a valid data point. The original sample data point collected in February 2013 was not representative of actual arsenic concentrations at 18-1B and that the verification sampling results are an accurate reflection of conditions at this portion of the Property. The UCL95 for the 24-48 in bls data set with the revised 18-1B data point was 1.77 mg/kg, in compliance with the Florida Residential Exposure SCTL of 2.1 mg/kg.

The ProUCL-recommended UCL95 for 0-24 in bls, however, was 8.44 mg/kg, in excess of the Florida Residential Exposure SCTL. Generally higher arsenic impacts were expected at the surface of the Property as arsenical herbicides were applied to the ground surface of the GCPAs onsite. It was interesting to note that the location and type of GCPAs onsite appear to provide good indicators of the horizontal distribution of arsenic impacts to unsaturated soil. Soil samples collected during the transect soil sampling program exhibited arsenic concentrations, which correlated well with the definitions of specific types of GCPAs. When transect soil sample data from collected from 0-2 ft bls within the Property's GCPA fairways were compiled and analyzed using the ProUCL software, the recommended UCL95 was 1.77 mg/kg in compliance with the Florida Residential Exposure SCTL. The data sets representing the remaining types of GCPAs (greens and tees) as well as non-playing areas (rough) reflected UCL95 average concentrations of arsenic in excess of the 2.1 mg/kg SCTL.

Based on the existence of low permeability soils at or near the ground surface, it seemed likely that the prompt shedding of stormwater and irrigation from the fairways served as a transport mechanism to carry arsenic impacts towards the surrounding rough and non-playing areas of the Property.

5. Vertical Definition Sampling. A body of soil analytical data which supported the definition of a conceptual site model (CSM) for depicting the spatial (and vertical) distribution of arsenic impacts to the unsaturated soil onsite was prepared. Two (2) additional soil sampling efforts were conducted to further support and validate the CSM for the Property.

On Jun. 26, 2013, a sampling event on the South Course with the advancement of 20 soil borings (AA through TT) to a depth of 4 ft bls were conducted. At the first four sample locations (AA-DO), discrete soil samples were collected at 0-1 ft bls, 1-2 ft bls, 2-3 ft bls and 3-4 ft bls. At the remaining 15 sample locations (EE-TT), discrete soil samples were collected at 0-1 ft bls and 1-2 ft bls. A review of the analytical data clearly depicts a vertical delineation in arsenic impacts to unsaturated soil onsite. More than 70 percent of the arsenic loading is within the 0-1 ft layer and more than 87 percent of the arsenic loading is located within the 0-2 ft soil layer.

Based on this data, a further refinement of the vertical definition of arsenic impacts across the entire Property was conducted. So as to provide a data set representative of the entire Property, both the North and South Courses were divided into 25 quadrants, approximately 90,000 sq ft in area. Within each quadrant, four discrete sample points were randomly designated. On Jul. 22 and 23, 2013, the collection of 100 discrete soil samples were collected from both the North and South Courses. Samples were collected from the 1-2 ft bls interval and the four discrete samples collected from each quadrant were composited into one sample for analysis by EPA Method 6010 for total arsenic.

Arsenic concentrations ranges in the soil samples are as follows:
Samples from the North Course ranged from 2.8 mg/kg to 0.536 mg/kg;
Samples from the South Course ranged from 11 mg/kg to 0.31 mg/kg.

The composite arsenic concentration data from the North Course and the South Course was compiled and analyzed using the USEPA's ProUCL Version 5 software. The program was run with all possible distribution tests in order to determine the distribution type that the data set followed best. The ProUCL-recommended UCL95 for arsenic concentrations in soil was 1.2 mg/kg for North Course and 2.5 mg/kg for the South Course.

The July 2013 sampling results clearly depict arsenic impacts limited to the upper one ft within the North Course. This data confirms the prior SAR results indicating there were no samples that exceeded the Florida Residential Exposure SCTL for arsenic below 2 ft bls and further amends this result that there were no samples that exceeded the Florida Residential Exposure SCTL for arsenic below one ft bls.

Accordingly, the soil contamination was identified within the property as described above, and a Remedial Action Plan (RAP) was formed in a step-by-step process as follows:

a. Documenting existing contaminant distributions throughout the Property,

b. Defining specific parcels of various proposed land uses within the Property,

c. Identifying the existing SCTLs or calculating alternative SCTLs for each proposed land use;

d. Comparing the existing arsenic concentrations and contaminant distributions within each specific land use parcel with applicable SCTLs for the respective proposed land use,

5. Selecting a risk-based remedial strategy to bring existing arsenic impacts within a specific land use parcel into compliance with applicable SCTLs based on proposed land use; and

6. Provide a description of construction-related procedures and requirements for a Remedial Action Plan (RAP) implementation.

D. Soil Blending Study.

As detailed above, soil sampling previously confirmed arsenic impacts within the Property in excess of the Florida Residential soil cleanup target level (SCTL) of 2.1 mg/kg appear to be limited to the upper two (2) ft of the Property other than the golf course fairways. Soils encountered at depths greater than 2 ft bls did not exhibit statistically elevated arsenic concentrations. Additional soil sampling appeared to indicate that the arsenic impacts are further delineated within the top one foot of soil based on the historical surface application of arsenical herbicides.

As part of the proposed development plan for the Property, the earthwork contractor was required to excavate the layer of organic-rich muck material from beneath the proposed building pads within each residential parcel. This process will involve the excavation and replacement of in-situ soils from each lot. Due to the aggressive mixing which occurs during the excavation and subsequent placement and compaction f this material, it was determined that there was an opportunity to limit the amount of arsenic-impacted soil to be managed during the Property SMP/RAP.

To provide the County with a proof of concept, a pilot study was completed replicating the excavation and soil placement process for proposed residential lots onsite. Soil remediation was completed with the process described herein at four (4) proposed residential lots.

1. Pre-Excavation Sampling. With the intent to evaluate the representative arsenic concentrations for the in-situ soil, a series of eight (8) pre-excavation soil borings were advanced within each of the proposed lots. Four (4) soil borings were located outside of the building pad and samples composited for 0-1 ft bls, 1-2 ft bls and 2-4 ft bls for analysis of total arsenic. Four (4) soil borings were collected from within the building pad envelope and composite samples were collected from 0-1 ft bls, 1-2 ft bls, 2-4 ft bls and 4-6 ft bls for total arsenic. The pre-excavation sampling results confirm SAR/SARA data, which limits onsite arsenic impacts to the upper 1-ft of soil onsite.

2. Soil Excavation and Stockpile Sampling. The soil excavation process was then conducted within each of the designated pilot study lots. The top 0-0.5 ft bls layer of top soil and organics was scraped from the entire lot to the south side. This material was designated Stockpile 1 and covered with visqueen. The next layer of soil from 0.5 ft bls to 1.0 ft bls was scraped from the entire lot and stockpiled on the west side (Stockpile 2). Soil from 1-2 ft bls across the lot as well as excavated material from within the building pad was stockpiled to the north (Stockpile 3). The fill material from within the building pad for Stockpile 3 was generated by excavating from 2 ft bls until muck was encountered. The anticipated depth and thickness of the muck layer was 5-6 ft bls and 1-2 ft, respectively. The muck stockpile was designated Stockpile 4.

Representative soil samples were collected from each pilot study lot stockpile in accordance with Chapter 62-713, Table A of the Florida Administrative Code (F.A.C.) for analysis of total arsenic. The results of the stockpile sampling effort continue to reflect data in line with the pre-study expectations that onsite arsenic impacts are limited to upper one (1) ft onsite. The stockpile sampling revealed a further delineation of arsenic impacts to the surficial 0-0.5 ft layer of topsoil and organics. This material clearly exhibits the primary impacts with the 0.5 ft bls to 1.0 ft bls layer (Stockpile 2) exhibiting arsenic concentrations at or marginally below the Residential SCTL of 2.1 mg/kg.

3. Soil Blending and Verification Sampling. Once the results of the stockpile sampling confirmed that Stockpiles 2-4 within each of the Pilot Study lots were either below or proximal to the Florida Residential Exposure SCTL of 2.1 mg/kg, Stockpiles 2 and 3 were used to backfill the building envelope excavation and return the lot to approximate grade. Stockpile 4 was then used as top dressing within the lot but outside of the proposed building pad.

A post-soil placement soil sampling effort was then completed for the fill material within the excavation and the top-dressed organic material. Four (4) soil borings were advanced from within the building pad envelope and four (4) composite soil samples collected from the fill material for analysis of total arsenic. Four (4) additional soil samples were collected from the top dressed material (0-1 ft bls) within the entire lot for analysis of total arsenic. The results of the post-blending sampling proved the process as a potential remedial step onsite. Other than two minor exceedances for samples collected from 0-1 ft bls likely due to the heavy rainfall during the sampling, and the likelihood that construction equipment tracked surficial arsenic impacts from the adjoining undisturbed lots, the data was positive. The only data point outside expectations was the Lot 45 (1-2 ft layer) at 5.5 mg/kg. The resampling of Lot 45 prior to reaching final conclusions on the disposition of the placed material was recommended.

b. Soil Blending.

Water was introduced into the mixing area (excavated portion of Lot 45) using a PT3-100HAT-570 gallon per minute trash pump with a Honda GX Engine. A suction line introduced a surfactant (0.005 GPM) and an emulsifier (0.0025 GPM) into the water. The first and second portions of soil (Stockpile 2 and Stockpile 1) were introduced into the mixing area at a 7:1 ratio. A vibroflotation machine was then used to mix and blend the soil.

The completed soil management pilot study replicated actual site development construction activities with the intent of potentially utilizing these activities as a part of a proposed SMP/RAP. The post soil blending sampling program provided the Division with confirmation that the proposed combination of segregating arsenic-impacted soil and the mixing of the remaining onsite soils during proposed construction activities can result in all soils within the residential parcel to be in compliance with the Florida Direct Exposure Residential.

While the foregoing written description of the invention enables one of ordinary skill to make and use what is considered presently to be the best mode thereof, those of ordinary skill will understand and appreciate the existence of variations, combinations, and equivalents of the specific embodiments, methods, and examples herein. And, although the present invention has been discussed in considerable detail with reference to certain preferred embodiments, other embodiments are possible. Therefore, the scope of the appended claims should not be limited to the description of preferred embodiments, methods, and examples contained herein.

What is claimed is:

1. A method of remediating a contaminant from soil comprising:
a) identifying a land parcel having at least one soil contaminant that exceeds a desired level of contaminant;
b) identifying within the land parcel, a portion of soil having a concentration of the at least one soil contaminant that exceeds the desired level of contaminant;
c) identifying the concentration of the soil contaminant in the portion of soil;
d) excavating the identified portion of soil with the at least one soil contaminant;
d) calculating an amount of uncontaminated soil to be mixed with the portion of soil with at least one soil contaminant to achieve a desired level of contaminant;
e) mixing the excavated portion of soil with the at least one soil contaminant with uncontaminated soil to form a mixed soil, the mixed soil conforming to the desired level of contaminant within the soil; and
f) blending the mixed soil with soil vibration and water as a hydraulic medium, such that the contaminant is distributed substantially consistently throughout the mixed soil.

2. The method according to claim 1 wherein the method further comprises
i) identifying within the land parcel, a portion of soil which is uncontaminated with the soil contaminant, or has a lower concentration of the soil contaminant than the portion of soil having a concentration of the soil contaminant that exceeds the desired level of contaminant; and
ii) using the portion of soil which is uncontaminated with the soil contaminant, or has a lower concentration of the soil contaminant in step e) to mix with the excavated portion of soil with the at least one soil contaminant, such that the mixed soil conforms to the desired level of contaminant within the soil.

3. The method according to claim 1 wherein the method further comprises blending the mixed soil in situ to conform to the desired level of contaminant.

4. The method according to claim 1 wherein the blending step comprises utilizing a vibroflotation machine to blend the contaminated soil with the uncontaminated soil with soil vibration using water as a hydraulic medium.

5. The method according to claim 1 wherein the soil contaminate comprises a heavy metal.

6. The method according to claim 1 wherein the soil contaminate comprises Arsenic.

7. A method of remediating a contaminant from soil comprising:
a) identifying a land parcel having at least one soil contaminant that exceeds a desired level of contaminant;
b) identifying within the land parcel,
(i) a first portion of soil having a concentration of the at least one soil contaminant that exceeds the desired level of contaminant; and
(ii) a second portion of soil which is substantially uncontaminated with the soil contaminant;
c) identifying the concentration of the soil contaminant in the first portion of soil;
d) excavating the first portion of soil;
e) excavating the second portion of soil;
f) calculating an amount of the first portion of soil to be mixed with the second portion of soil to attain the desired level of contaminant; and
g) mixing the excavated portion of the first portion with the second portion of soil to form a mixed soil, the mixed soil conforming to the desired level of contaminant within the soil;
h) blending the mixed soil with soil vibration and water as a hydraulic medium, such that the contaminant is distributed substantially uniformly throughout the mixed soil.

8. The method according to claim 7, wherein step h) is performed in situ.

9. A method of remediating a contaminant from soil comprising:
a) providing a contaminated soil, the contaminated soil having one or more soil contaminants that exceeds a desired level;
b) identifying the concentration of one or more soil contaminants in the contaminated soil;
c) providing a quantity of clean soil, the clean soil being substantially free of hazardous substances;
d) calculating a ratio contaminated soil to be mixed with clean soil to achieve a desired level of at least one of the soil contaminants;
e) mixing the contaminated soil with the clean soil contaminant in the calculated ratio to form a mixed soil; and
f) blending the mixed soil with soil vibration and water as a hydraulic medium, such that the contaminated soil is distributed substantially consistently throughout the mixed soil.

10. The method according to claim 9 wherein the contaminated soil comprises two or more soil contaminants and the soil mixing and blending remediates at least two contaminants.

11. The method according to claim 9 further comprising treating one of the mixed soil or the contaminated soil with a second soil remediation process.

12. The method according to claim 11 wherein the second soil remediation process is selected from the group consisting of aeration, bioremediation, in situ oxidation, soil washing, solid vapor extraction and thermal desorption.
